(19) United States
(12) Patent Application Publication
(10) Pub. No.: US 2012/0304846 A1
(43) Pub. Date: Dec. 6, 2012

(54) BELLS AND METHODS OF THEIR DESIGN AND PRODUCTION

(75) Inventor: Neil Maxwell McLachlan, Carlton (AU)

(73) Assignee: THE UNIVERSITY OF MELBOURNE, Parkville, Victoria (AU)

(21) Appl. No.: 13/513,370

(22) PCT Filed: Dec. 2, 2010
(86) PCT No.: PCT/IB10/55543

§ 371 Date: Aug. 24, 2012

(30) Foreign Application Priority Data
Dec. 2, 2009 (AU) 2009905894

(51) Int. Cl. G10D 13/08; B23P 17/04

(52) U.S. Cl. 84/406; 29/592

(57) ABSTRACT

A method for designing a bell, comprising defining a shape of a body wall of the bell in a general form of a frustum that is open at both ends, and determining an optimal size and location of a stiffening element to be added to said bell for increasing a frequency ratio of a second mode of vibration of the bell relative to one or more other modes of vibration to be tuned in the bell. Also, a method of producing a bell, and a bell so produced.

### RELATED APPLICATION

This application is based on and claims the benefit of the filing date of AU application no. 2009905894 filed 2 Dec. 2009, the content of which as filed is incorporated herein by reference in its entirety.

### FIELD OF THE INVENTION

The present invention relates to bells and methods of designing and producing same. More particularly, the present invention relates to harmonic bells and methods of producing such bells.

### BACKGROUND OF THE INVENTION

A bell is an object that undergoes vibration and radiates energy into the air to make sound. Typically, bells are hollow, cone-shaped objects that are induced to make a sound after being struck, usually by a striking device associated with the bell known as a clapper. There are many different types of bells ranging from very large bells associated with churches to very small bells used as ornamentation on clothing.

Sounds produced by freely vibrating objects, such as bells, usually consist of multiple tones, often described as the fundamental (lowest frequency tone) and its overtones. Air-columns and stretched strings naturally vibrate in such a way as to produce overtones at frequencies at integer multiples of the fundamental frequency. Such a system of overtones is known as the harmonic series. An important property of the human auditory system is that sounds with harmonically tuned overtones usually produce a strong and singular sensation of a musical pitch with a frequency close to that of the fundamental frequency of the harmonic series.

Owing to the quality of their sound, harmonically tuned bells (viz. “harmonic bells”) have many musical advantageous compared with non-harmonically tuned bells. This is particularly the case when bells are intended to be used to play music, either independently or with other musical instruments.

The vibration of bells may be regarded as the linear combination of different motions known as the bell's “normal modes of vibration”, or simply “modes”. Each mode has particular directions and extents of motion in regions of the bell, which occur with specific frequencies of oscillation. Apart from so-called “rigid body modes” which do not contribute to a bell's sound, all modes have nodal lines or points at which the bell surface is stationary. From analytical theory it is known that the frequency of modes of rigid bodies may be altered by substantially changing only the effective stiffness of the body with respect to the mode shape being altered, by substantially changing only the effective mass inertia of the body with respect to the mode shape being altered, or by both simultaneously. The frequency of each mode depends on the ratio of the stiffness of the bell for that mode to the inertia of the bell material being set in motion, so the specific shape of a bell directly affects the frequencies of its overtones. The ratios of these overtone frequencies to the fundamental frequency of the bell are generally preserved when the bell is scaled, thereby producing a similar sound across a range of musical pitches, as is usually required for a musical instrument.

The acoustically important modes of a bell are those in which displacement occurs in a direction normal to the bell's surface, as these modes are able to most efficiently radiate their energy in the air in the form of sound. In this specification, it is to be understood that a reference to “modes” is a reference only to modes in which vibration occurs in a direction normal to the bell's surface. Similarly, a reference to “frequencies” is a reference only to frequencies due to modes in which vibration occurs in a direction normal to the bell's surface. Furthermore, in this specification, a reference to the first—for example—three modes is a reference to the lowest frequency mode, the second lowest frequency mode and the third lowest frequency mode. Other references to the first number of modes are to be construed similarly.

The traditional naming convention of the modes according to the number and location of nodes, or stationary lines, of the mode in question is also used herein. That is, modes are referred to as an ordered pair (m, n) where m is the number of meridial nodal lines and n is the number of nodal rings. The (2,0) mode is the lowest frequency acoustically important mode (“the fundamental”).

In this specification, a reference to the “mode sequence” for a bell is a reference to a list of the modes of the bell, in order of the frequency of the modes and starting with the lowest frequency mode. Similarly, references to a “frequency sequence” are references to a list of the modal frequencies of a bell starting with the lowest modal frequency. Furthermore, in this specification, references to frequencies “being tuned”, and similar expressions, are references to modal frequencies which are desired to be modified to substantially adopt particular values. For example, in the case of a harmonic bell wherein the first five frequencies are to be substantially in an harmonic sequence, the first five frequencies are all “being tuned” or “to be tuned”. In a similar vein, a reference to a “tuned bell” is a reference to a bell that has modal frequencies that have been tuned.

Finite Element Analysis (FEA) methods for numerically estimating the normal modes of a solid body, and their associated frequencies, are well known. These methods can be used when the geometry of the solid body is too complex to be solved by analytically derived equations. In finite element methods the body is notionally divided into many elements. The geometry of this division is known as a “mesh”. Individual elements are geometrically defined by “nodes”, which are points on the boundaries of elements at the intersection points of the mesh. Elements may have a wide range of properties by virtue of the equations defining their mechanical properties and the values of variables used to model material properties. It is common to use so-called “solid elements” with eight nodes to define a volume and so-called “shell elements” with four nodes to define a surface. A shell thickness must also be provided in the mathematical definition of shell elements.

Certain harmonic bells are described in U.S. Pat. No. 6,915,756. Harmonic tuning in these bells was achieved by determining a preferable shape for the bell body and then optimising that shape by modifying certain characteristics of the body such as the wall shape and thickness. However this production method requires that the bell walls vary significantly in thickness along their length, thereby limiting the method to relatively complex casting and machining processes. Such harmonic bells are therefore expensive to produce and sell.

### SUMMARY OF THE INVENTION

According to a first broad aspect, the present invention provides a method for designing a bell, comprising:
defining a shape of a body wall of the bell in a general form of a frustum that is open at both ends; and
determining an optimal size and location of a stiffening element to be added to said bell for increasing a frequency ratio of a second mode of vibration of the bell relative to one or more other modes of vibration to be tuned in the bell.

It will be appreciated by those in the art that the term “frustum” is not employed in its precise mathematical sense, but rather to convey the general form of the bell. For example, the planes of the two ends of the bell may not be precisely parallel (as would be required of an ideal frustum), and the shortest path along the wall between those ends may not be straight.

In one embodiment, the method comprises determining said optimal size and location of the stiffening element by finite element analysis or by experiment.

The method may comprise determining the size and location to maximally increase a frequency of the second mode whilst minimally increasing a frequency of a third mode of vibration.

In a certain embodiment, the method locating the stiffening element at a region of the wall that affects a stiffness of the second mode whilst minimally affecting a stiffness of the third mode.

The method may comprise locating the stiffing element on an interior surface of the wall at a minimal distance from a larger rim of the bell for which negligible stress is observed for a third mode of vibration.

The method may comprise fine-tuning a frequency of a fundamental mode of vibration by reducing a stiffness of the frustum by inserting tuning slots in a rim of the smaller end of the frustum. This embodiment may include adjusting the lengths of the tuning slots.

The method may comprise fine-tuning a frequency of third and fourth modes of vibration by reducing a stiffness of the frustum by inserting tuning slots in a rim of the larger end of the frustum. This embodiment may include adjusting the lengths of the tuning slots.

In one embodiment, the method:
(i) defining a shape of the body wall of the bell in the general form of a truncated cone which is open at both ends;
(ii) determining the optimal size and location of a stiffening element to raise the frequency ratio of the second mode relative to the other modes to be tuned in the bell;
(iii) fine-tuning the frequency of the fundamental mode by reducing the stiffness of the cone by inserting tuning slots of varying length in the rim of the smaller end of the cone; and
(iv) fine-tuning the frequency of the third and fourth modes by reducing the stiffness of the cone by inserting tuning slots of varying length in the rim of the larger end of the cone.

Numerical methods like FEA are only capable of estimating the mode shapes and frequencies of a particular, given geometry. Tuning the modal frequencies of a rigid body requires that modal analysis be undertaken for a range of geometries of that body.

Once the body wall shape of the bell model is defined, the optimal size and location of the stiffening element may be determined. In this embodiment, the stiffening element maximally increases the frequency of the second mode whilst minimally increasing the frequency of the third mode by being located at a region of the bell wall that affects the stiffness of the second mode without affecting the stiffness of the third mode. The stiffening element may be constructed of any suitable material such as, but not limited to sheet metal or ceramic material.

In a particular embodiment, the stiffening element is in the shape of a ring.

It should be understood that other characteristics of the body wall can also be modified in accordance with the present invention. These may include, but are not limited to, mass loading the bell wall to specifically reduce the frequency of certain modes. Mass loading involves providing highly localized masses to specific locations on the bell wall in such a way as to increase mass inertia but not increase the stiffness. The closer these masses are to the large rim of the bell the more they will lower the frequency of higher order modes relative to lower order modes.

The modes of bells with meridial lines occur in pairs in which each mode of the pair has the same eigenvalues and nominally equal frequency, but is shifted in phase such that the maximum vibratory displacement of one of the pair occurs at the minimum of the other. If by reason of the method of manufacture, one of a pair of modes is higher in frequency, placing the mass at the maximum of vibration of that mode can lower its frequency to match the other mode.

Once the stiffening element is in place on the body wall of the bell model, the stiffness of the cone can be modified by inserting tuning slots at suitable positions on the body wall of the bell.

In a particular embodiment, these positions are in the rims of the smaller and/or larger end of the cone. Inserting tuning slots in the smaller end of the cone generally only lowers the frequency of the fundamental frequency (a 2,0 mode shape). Inserting tuning slots in the larger end of the cone generally reduces the frequency of higher order circumferential modes more than lower order circumferential modes. The insertion of tuning slots tunes the bell such that it is harmonic.

As would be known to a person skilled in the art, the body wall of the bells of the present invention may be constructed from any material with suitable physical properties, for example, able to be obtained in a sheet of constant thickness, able to support audible modes of vibration. Such materials may include, but are not limited to, metal or ceramic materials.

The body wall of the bell of the present invention may be produced from a continuous sheet of material as a conical frustum or truncated cone (for example made by rolling) or as a faceted truncated cone (made from a series of folds). Fabricating a truncated cone or faceted truncated cone from, for example, sheet metal requires that the metal be joined along a seam. As noted herein, the cone may be manufactured from a single piece of metal in which case there will be a seam on one side of the cone. The cone may also be manufactured from multiple pieces in which case there will be multiple seams.

It is common to weld sheet metal joins. It is possible to weld the seam or seams of a bell made according to the present specification such that the stiffness and mass of the metal in the seam is identical to the metal elsewhere in the bell. In this case there will be no difference in the frequencies of modes with the same eigenvalues (as predicted for the circular cone in FIGS. 1A and 1B, as described below). If the metal in the seam varies in stiffness or mass from the metal elsewhere in the bell the frequency of one of a pair of modes with the same eigenvalues may be effected more than the other. This may result in two closely tuned overtones that interfere with each other and cause the bell sound to beat. The beat frequency is the difference in the frequency of the pair of modes with the same eigenvalues and may be tuned by mass loading one mode, lengthening slots in the rim of the bell that predominantly effect the stiffness of the higher frequency mode, or thinning the stiffening element at locations that predominantly effect the stiffness of the higher frequency mode.

The effect of any discontinuities in the mass or stiffness of the bell due to the seam may be distributed to both modes in each of the lower order pairs of modes by fabricating the truncated cone from two unequal segments. For example, if the truncated cone was constructed from 16 facets, a second seam could be placed at the seventh fold from the first seam, or at an angle of 157.5°. A seam will then occur in regions of displacement for both of the modes in each pair and so will substantially reduce the frequency difference between the modes.

As would be known to a person skilled in the art, methods of inserting tuning slots will depend on what material the body wall of the bell is made out of. These methods may include, but are not limited to, incision by mechanical means, laser cutting and the like.

If bells of different pitches are required, such as for a musical instrument, the frequency of the bell modes can be changed without changing the wall thickness of the bell by scaling the bell in three dimensions where the changes in the frequencies of the modes will be approximately proportional to the inverse square of the scale factor.

In a second broad aspect, the present invention provides a method of producing a bell, comprising:
creating a design of a bell by designing the bell according to the method described above; and
manufacturing the bell according to the design.

In a third broad aspect, the present invention provides a bell, comprising:
a body wall in a general form of a frustum that is open at both ends; and
a stiffening element sized and located to increase a frequency ratio of a second mode of vibration of the bell relative to one or more other modes of vibration of the bell to be tuned in the bell.

The stiffening element may be added to the wall of the bell, or manufactured integral with the wall.

In one embodiment, the present invention provides a bell, the bell comprising a body wall having a constant thickness and wherein at least two modes of the bell have frequencies tuned to a harmonic series.

In a particularly preferred embodiment, the bell of the present invention has at least three modes having frequencies tuned to a harmonic series.

In another embodiment, the bell of the present invention is tuned by modifying one or more characteristics of the body wall. In particular, a characteristic to be modified is stiffness.

In yet another embodiment, the stiffness of the body wall of the bell of the present invention, for a particular mode of vibration to be tuned, is modified by the addition of tuning slots and/or a stiffening element to the body wall.

In addition to stiffness, another characteristic of the body wall which could be modified in mass inertia.

In yet another embodiment, the mass inertia of the body wall of the bell of the present invention, for a particular mode of vibration to be tuned, is modified by the addition of localized mass to the body wall.

Advantageously, the methods of the present invention allow the production of harmonic bells predominantly from material of constant thickness, thereby facilitating economical manufacture of harmonic bells.

It should be noted that any of the various features of each of the above aspects of the invention can be combined as suitable and desired.

### BRIEF DESCRIPTION OF THE FIGURES

In order that the invention may be more clearly ascertained, embodiments will now be described, by way of example, with reference to the accompanying drawing, in which:

FIGS. 1A and 1B are elevation and plan diagrammatic representations, respectively, of a model of a truncated circular cone (or conical frustum) created as a first step in the modelling of a bell according to a first embodiment of the present invention;

FIGS. 2A to 2D are diagrammatic elevation representations, respectively, of the vibratory displacements of the first three purely circumferential modes (2,0, 3,0 and 4,0) and the first mode with a nodal ring (2,1) for the bell of FIGS. 1A and 1B, as calculated by FEA (shown as greyscale plots where maximum displacement is lightest);

FIGS. 2E to 2H are negative versions of FIGS. 2A to 2D, respectively (hence greyscale plots where maximum displacement is darkest);

FIGS. 3A and 3B are elevation and plan diagrammatic representations, respectively, of a bell in the form of a truncated circular cone or conical frustum with stiffening ring in 3 mm mild steel material, according to the first embodiment of the present invention;

FIGS. 4A and 4B are elevation and plan diagrammatic representations, respectively, of a faceted truncated circular cone bell with stiffening ring and tuning slots and scallops in 3 mm mild steel material, according to a second embodiment of the present invention; and

FIG. 5 is a diagrammatic representation of the unfolded sheet metal components of the bell of FIGS. 4A and 4B, as prepared for metal cutting and fabrication.

### DETAILED DESCRIPTION OF PREFERRED EMBODIMENTS OF THE INVENTION

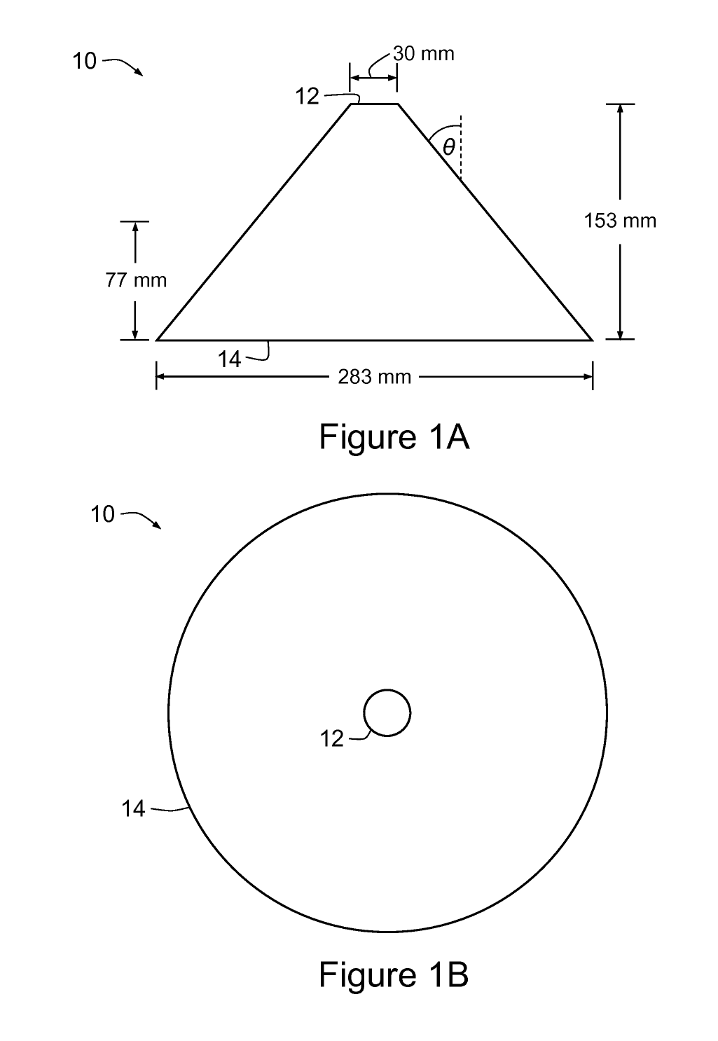

A finite element model of a truncated cone (i.e. a conical frustum) was created using solid elements, as shown at 10 in FIG. 1, as a first step in the modelling of a bell according to a first embodiment of the present invention. Truncated cone 10 was defined by the diameters of the smaller end 12 and larger end 14 of truncated cone 10 and the height of truncated cone 10. The frequency ratios of the overtones due to modes without nodal rings to the fundamental mode frequency are generally greater than the harmonic series. The frequency ratios reduce as the cone angle θ relative to a cylinder increases up to an angle of around 40°. The frequency ratios then begin to increase as cone angle θ increases and the geometry becomes closer to a disk. The cone angle θ was systematically altered to find the dimensions for which the frequency ratios were as small as possible.

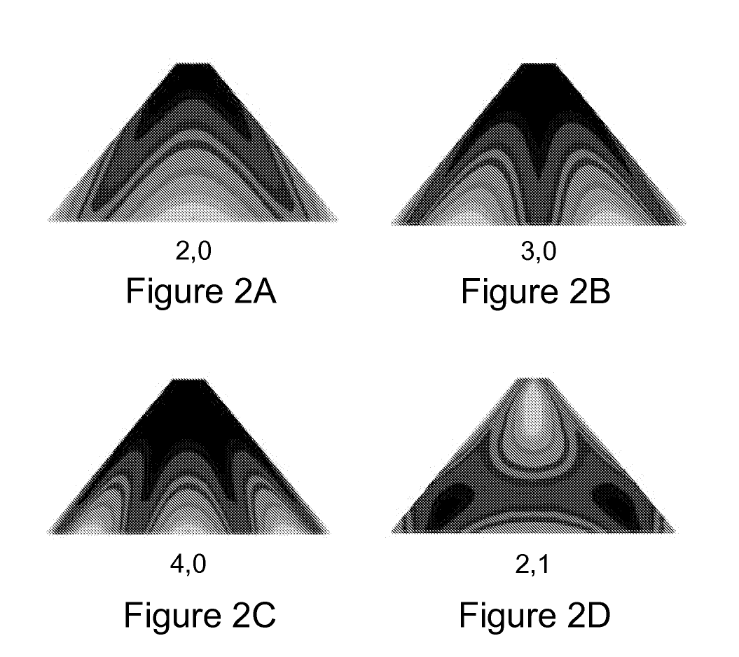

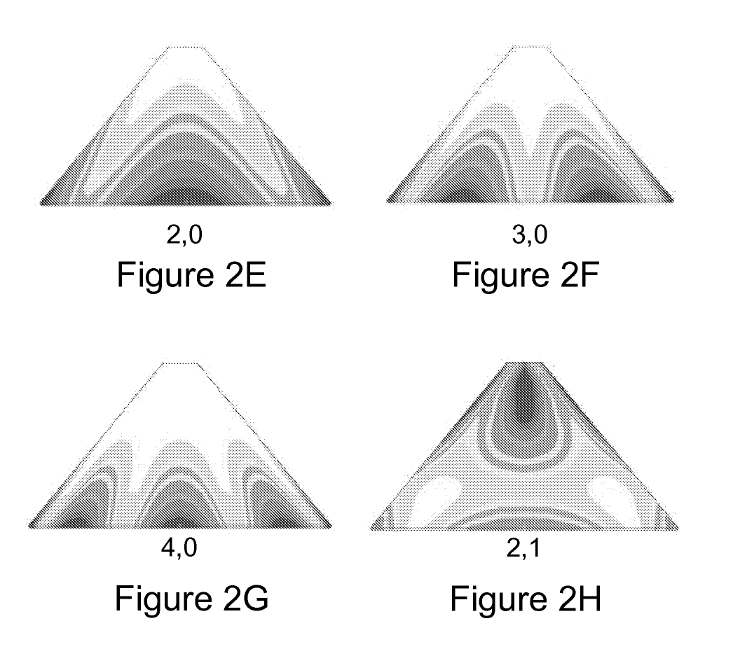

The first four modes of truncated cone 10 are shown in FIGS. 2A to 2D. FIGS. 2A to 2D are diagrammatic elevation representations, respectively, of the vibratory displacements of the first three purely circumferential modes (2,0, 3,0 and 4,0) and the first mode with a nodal ring (2,1) for truncated cone 10, as predicted by FEA. The results are shown as greyscale plots where maximum displacement is lightest. (FIGS. 2E to 2H are negative versions of FIGS. 2A to 2D, respectively, and are provided for clarity; FIGS. 2E to 2H are thus greyscale plots in which maximum displacement is darkest). The first three of these modes exhibit only meridial nodal lines. The fourth mode, shown in FIG. 2D, also exhibits a nodal ring.

It can be observed in FIGS. 2A to 2D that the vibratory displacements at the smaller end 12 of truncated cone 10 are greater for the fundamental frequency (2,0 mode) than for the higher order modes without nodal rings. Vibratory displacements generally shift to the proximity of the larger end 14 of truncated cone 10 as the order of modes without nodal rings increases. Increasing the diameter of the smaller end 12 reduced the stiffness of the fundamental mode far more than other modes without nodal rings and thereby reduced the frequency of the fundamental relative to these modes.

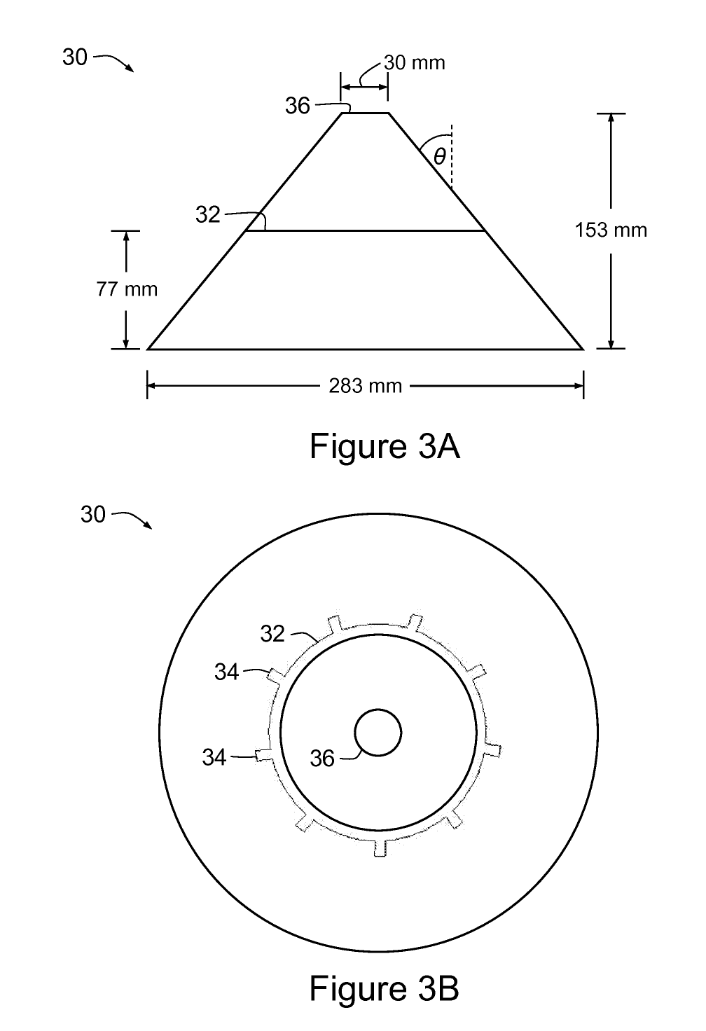

Generally in truncated cones the frequency ratio of the second mode was found to be less than 2 when the higher frequency modes were tuned to the harmonic series. To correct this the extent of stress distributions for the third mode was observed from the finite element model. Referring to FIGS. 3A and 3B, which are plan and elevation views comparable to those of FIGS. 1A and 1B, a bell 30 was modelled according to this embodiment with a stiffing ring 32 attached to the inside of truncated cone 10 at the minimum height for which negligible stress was observed for the third mode. This location will have maximum effect on the frequency of the second mode and minimum effect on the third mode. Nine short, equally distributed tabs 34 were used to attach stiffing ring 32 to the bell wall. The internal diameter of stiffing ring 32 was adjusted to fine-tune the frequency ratio of the second mode relative to the other modes. Table 1 lists the modal frequencies predicted by a finite element analysis of the geometry of bell 30 with a 3 mm thick mild steel model. The first three modes are within 2% of the harmonic series.

Stiffening ring 32 was also found to increase the frequency of the fundamental. It was found that this could be corrected by inserting slots (not shown) of increasing length in the rim of the smaller end 36 of bell 30. Since higher order modes do not exhibit significant modal

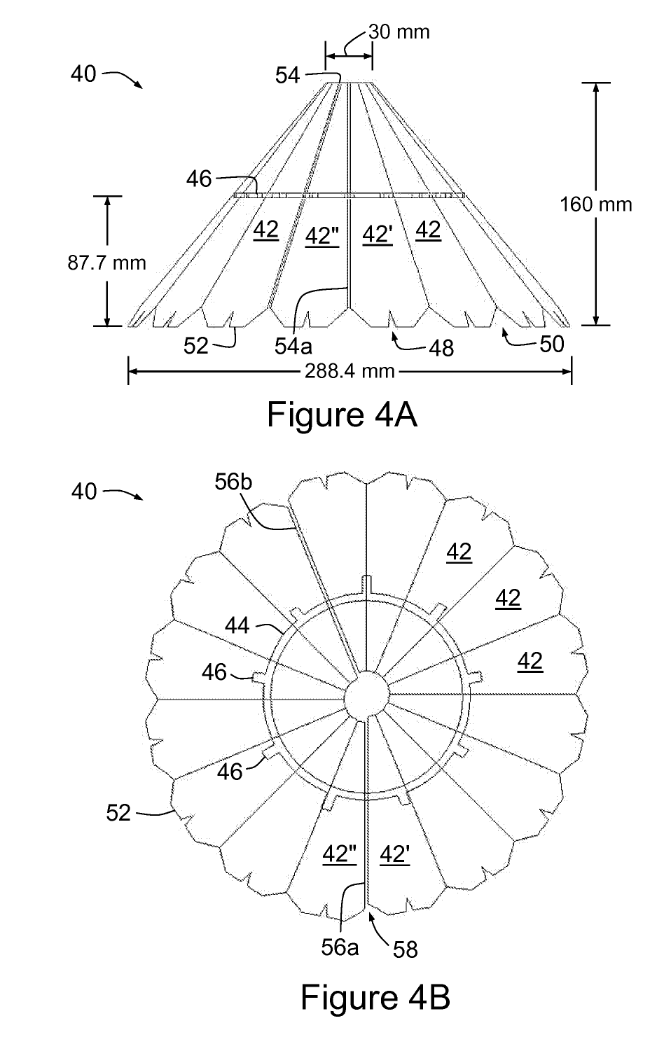

TABLE 1
the modes tuned and the frequencies and frequency ratios
predicted by FEA models for bell 30 of FIGS. 3A and 3B,
and for bell 30 of FIGS. 4A and 4B; and measured from a
physical bell constructed to be comparable to bell 40.

| | Truncated cone | | Faceted truncated | | Physical bell | |
|---|---|---|---|---|---|---|
| | (without tuning | | cone (tuned with | | (cf. bell of FIGS. | |
| | splits) | | offset split) | | 4A and 4B) | |
| Mode | Frequency | | Frequency | | Frequency | |
| type | (Hz) | Ratio | (Hz) | Ratio* | (Hz) | Ratio |
| 2.0 | 281 | 1 | 262 | 1 | 220 | 1 |
| 2.0 | 281 | | 267 | | | |
| 3.0 | 557 | 1.98 | 527 | 2.00 | 441 | 2.00 |
| 3.0 | 557 | | 531 | | | |
| 4.0 | 833 | 2.96 | 775 | 2.94 | 647 | 2.94 |
| 4.0 | 833 | | 778 | | | |
| 5.0 | 1202 | 4.28 | 1070 | 4.06 | 896 | 4.07 |
| 5.0 | 1202 | | 1075 | | | |
| 2.1** | 1900 | 6.76 | 1443 | 5.47 | 1087 | 4.94\hat{ } |
| 2.1 | 1900 | | 1446 | | | |

*Calculated from the average of each mode pair.
**For this model the 6.0 mode occurs at 1607 Hz, before the 2.1 mode.
\hat{ }Whist this frequency is harmonically tuned in this bell it was not reliably tuned in other examples; the 2.1 mode appears to be highly sensitive to the method of joining.

stress near the small end of the cone these slots only affect the fundamental frequency. The frequency ratios of the third and fourth mode were reduced to tune them to the harmonic series by inserting slots of increasing length in the rim of the larger end of the cone. If these modes could not be tuned correctly for a given truncated cone shape, the shape was adjusted and the process was repeated until minimum tuning errors were achieved.

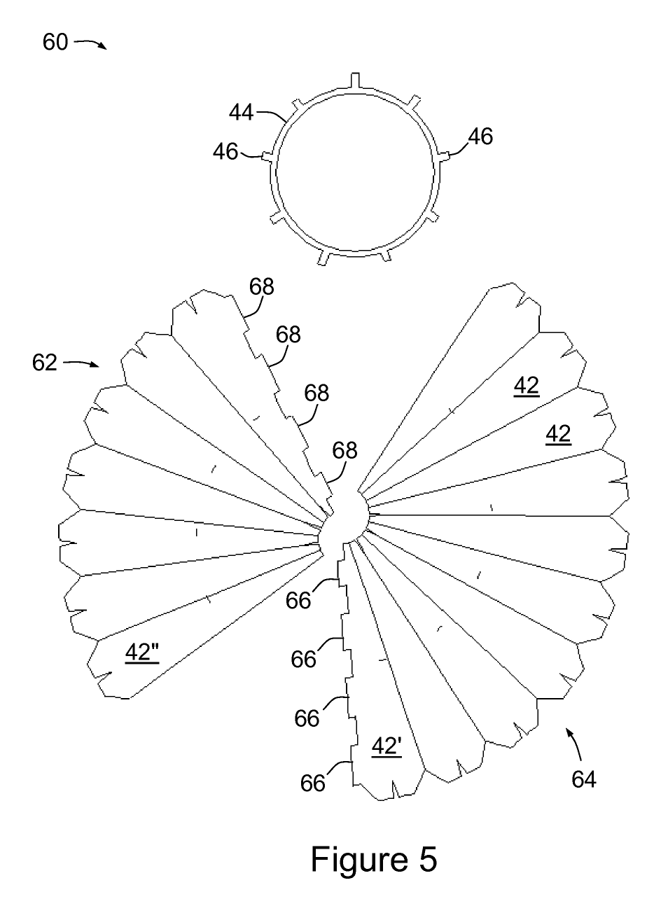

FIGS. 4A and 4B are elevation and plan diagrammatic representations, respectively, of a model of a faceted truncated circular cone bell 40 according to a second embodiment of the present invention. Bell 40, modelled as being of folded 3 mm thick mild steel material, comprises 16 facets or sectors 42, a stiffening ring 44 attached internally with tabs 46 to the bell wall, and both tuning slots 48 and tuning scallops 50 in larger rim 52. (Tuning slots may optionally also be provided, if desired, in smaller rim 54, to fine-tune the lowest frequency.) FIG. 5 is a diagrammatic representation 60 of the unfolded sheet metal components of bell 40 of FIGS. 4A and 4B, as would be prepared for use in metal cutting and fabrication, showing stiffening ring 44, first wall segment 62 and second wall segment 64.

Bell 40 has a seam 56a created by four discrete tabs 66 (see FIG. 5) extending from one 42′ of facets 42, which overlap with and are joined to an adjacent facet 42″ of the bell wall. Apart from these tabs 66, the two facets 42,42″ joined by tabs 6 are separated by a gap 58 of approximately 2 mm to prevent buzzing due to intermediate contact during vibration of bell 40. The average frequencies of the first four modes of this bell model are within 2% of the harmonic series for the musical note Middle C (see Table 1).

The effect of any discontinuities in the mass or stiffness of bell 40 due to seam 56a are distributed to both modes in each of the lower order pairs of modes by fabricating the truncated cone from two unequal segments 62, 64 (see FIG. 5). In this embodiment, in which bell 40 is constructed from 16 facets 42, a second seam 56b is placed at the seventh fold from the first seam 56a, or separated by an angle of 157.5°. (Second seam 56b is closed with tabs 68 comparable to tabs 66.) A seam 56a, 56b is thus provided in regions of displacement for both of the modes in each pair and so will substantially reduce the frequency difference between the modes.

Geometric discontinuities at a scale substantially smaller than the vibratory wavelength do not affect the frequency of the mode. Internal damping of materials generally cause higher frequency modes to reduce in amplitude compared to lower frequency, longer wavelength modes. It is possible to manufacture the faceted truncated cone from a flat sheet by a series of discrete folds. The faceted truncated cone sounds substantially the same as a circular truncated cone since the shorter wavelength modes at higher frequencies that would be affected by the facets are generally not excited and do not resonate efficiently.

When a bell is fabricated from a faceted truncated cone the stiffness of the bell is less in the flat parts compared to the folded parts of the bell. In the example of a 16 facet truncated cone (cf. FIGS. 4A and 4B), providing scallops the large rim of the bell in the region of the folds was found to reduce the mass inertia of the second mode without substantially lowering its overall stiffness. This effect was used to increase the frequency of the second mode relative to the higher order modes, since displacements of the higher order modes were more confined to the rim.

### EXAMPLE

When a bell was fabricated according to the second embodiment described above, and tested. The results are provided in Table 1.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in Australia or any other country.

1. A method for designing a bell, comprising:
defining a shape of a body wall of the bell in a general form of a frustum that is open at both ends; and
determining an optimal size and location of a stiffening element to be added to said bell for increasing a frequency ratio of a second mode of vibration of the bell relative to one or more other modes of vibration to be tuned in the bell.

2. A method as claimed in claim 1, comprising determining said optimal size and location of said stiffening element by finite element analysis or by experiment.

3. A method as claimed in claim 1, comprising determining said optimal size and location to maximally increase a frequency of the second mode whilst minimally increasing a frequency of a third mode of vibration.

4. A method as claimed in claim 1, comprising locating said stiffening element at a region of said wall that affects a stiffness of the second mode whilst minimally affecting a stiffness of the third mode.

5. A method as claimed in claim 1, comprising locating said stiffing element on an interior surface of said wall at a minimal distance from a larger rim of said bell for which negligible stress is observed for a third mode of vibration.

6. A method as claimed in claim 1, wherein the stiffening element is a ring.

7. A method as claimed in claim 1, comprising: i) fine-tuning a frequency of a fundamental mode of vibration by reducing a stiffness of the frustum by inserting tuning slots in a rim of a smaller end of the frustum, and/or ii) fine-tuning a frequency of third and fourth modes of vibration by reducing a stiffness of the frustum by inserting tuning slots in a rim of a larger end of the frustum.

8. A method as claimed in claim 7, including adjusting lengths of said tuning slots.

9. (canceled)

10. (canceled)

11. A method as claimed in claim 1, wherein said frustum i) is a conical frustum, ii) comprises a plurality of generally flat sectors, or iii) comprises folds between a plurality of respective pairs of said segments.

12. (canceled)

13. (canceled)

14. A method as claimed in claim 1, comprising mass loading said wall to reduce a respective frequency of one or more modes of vibration.

15. A method as claimed in claim 14, comprising providing localized masses at specific locations of the wall so as to increase mass inertia with minimal increase in stiffness.

16. A method of producing a bell, comprising:
creating a design of a bell by designing the bell according to the method of claim 1; and
manufacturing the bell according to the design.

17. A bell, comprising:
a body wall in a general form of a frustum that is open at both ends; and
a stiffening element sized and located to increase a frequency ratio of a second mode of vibration of the bell relative to one or more other modes of vibration of the bell to be tuned in the bell.

18. A bell as claimed in claim 17, wherein said optimal size and location of said stiffening element is derived from finite element analysis or from experiment.

19. A bell as claimed in claim 17, wherein said optimal size and location maximally increases a frequency of the second mode and minimally increases a frequency of a third mode of vibration.

20. A bell as claimed in claim 17, wherein said stiffening element is located i) at a region of said wall such that said stiffening element affects a stiffness of the second mode whilst minimally affecting a stiffness of the third mode, or ii) on an interior surface of said wall at a minimal distance from a larger rim of said bell for which negligible stress is observed for a third mode of vibration.

21. A bell as claimed in claim 17, wherein said stiffening element is provided on an interior surface of said wall at a minimal distance from a larger rim of said bell for which negligible stress is observed for a third mode of vibration.

22. A bell as claimed in claim 17, wherein the stiffening element is a ring:

23. A bell as claimed in claim 17, comprising tuning slots in a rim of a smaller end of the frustum, wherein said tuning slots reduce a stiffness of the frustum and thereby fine-tune a frequency of a fundamental mode of vibration of said bell.

24. A bell as claimed in claim 17, comprising tuning slots in a rim of larger end of the frustum, wherein said tuning slots reducing a stiffness of the frustum and thereby fine-tune a frequency of third and fourth modes of vibration.
